(19) United States
(12) Patent Application Publication
(10) Pub. No.: US 2009/0307878 A1
(43) Pub. Date: Dec. 17, 2009

(54) PERSONAL GEAR ATTACHMENT SYSTEM AND APPARATUS

(76) Inventor: Jon F. Kadas, Knoxville, TN (US)

Correspondence Address: LUEDEKA, NEELY & GRAHAM, P.C., P O BOX 1871, KNOXVILLE, TN, 37901, US

(21) Appl. No.: 12/482,888

(22) Filed: Jun. 11, 2009

Related U.S. Application Data
(60) Provisional application No. 61/060,630, filed on Jun. 11, 2008.

(51) Int. Cl. A44B 21/00; A44B 17/00; A44B 18/00; H01F 7/00

(52) U.S. Cl. 24/303; 24/1; 24/700; 24/306; 24/304

(57) ABSTRACT

An apparatus and method for attaching gear pieces to a webbed panel such as, for example, the Pouch Attachment Ladder System (PALS). Using the apparatus and method described herein, a gear piece can be attached to an application member configured for easy attachment to an interface member, the interface member preferably having been previously attached to a webbed panel.

### CROSS-REFERENCE(S) TO RELATED APPLICATION(S)

This application is a nonprovisional of and claims priority to U.S. Provisional Application Ser. No. 61/060,630 entitled “Personal Gear Attachment System and Apparatus” filed on Jun. 11, 2008, the entirety of which is incorporated herein by reference.

### FIELD

This disclosure relates to the field of apparatus and methods for carrying objects and materials. More particularly, this disclosure relates to personal gear attachment systems.

### BACKGROUND

The military and most law enforcement agencies currently use a personal gear attachment system referred to as Modular Lightweight Load-carrying Equipment or “MOLLE.” This system typically utilizes sewn webbing, in a matrix formation, referred to as Pouch Attachment Ladder System or “PALS.” Using the MOLLE system, gear (e.g., a modular pouch) with straps on the back can be attached to a webbing panel configured in the PALS format. In order to attach gear to the PALS panel, the straps of the gear piece are weaved into the PALS panel. The PALS system is an effective means of securely fastening many types of gear such as, for example, ammunition pouches, ordinance pouches, first aid kits, pouches for miscellaneous items (e.g. flashlights, knives, compasses, GPS unit), identification holders, canteens, liquid bladders, and other types of load-carrying equipment. The modular nature of the MOLLE and PALS systems affords a user the ability to customize placement of gear based on various factors including the type of gear being attached. However, there is an inherent drawback to the way conventional gear is attached using the MOLLE and PALS systems.

Weaving straps or similar devices of a gear item onto the back of load-carrying equipment and attaching such gear item to load-carrying equipment is not easily done. The conventional attachment process is time consuming and takes a fair amount of energy; and users often do not get the desired configuration of gear pieces assembled on a panel of PALS webbing during the first try. Disassembly of gear pieces can be equally cumbersome. Such characteristics are considerably undesirable for persons working in unforgiving environments such as combat zones or areas where criminal activity is a foot.

Therefore, there is a need for a quick attach and detach system compatible with the conventional MOLLE, PALS, and other similar systems.

### SUMMARY

The above and other needs are met by an interlocking apparatus for attaching a gear piece to a load-carrying equipment piece quickly and securely. More specifically, for example, the interlocking apparatus is configured for compatibility with the PALS and other similar webbed panel systems.

In a preferred embodiment, the apparatus includes a tab, an interface member, and an application member. The application member preferably includes a gear piece for attachment to a panel configured with PALS. The tab and the interface member may quickly and securely be attached to the panel as described herein. Thereafter, the application member may quickly and securely be engaged with the interface member so that the gear piece associated with the application member is substantially securely fastened to the panel.

More specifically, in a detailed aspect, embodiments of the invention provide an apparatus for attaching an object to a webbed panel, the apparatus including an application member including a first attachment means on a first surface of the application member and a second attachment means on a second surface of the application member; an interface member including a third attachment means along a first surface of the interface member and a fourth attachment means along a second surface of the interface member, wherein the first attachment means is configured for attaching the application member to an object, wherein the second attachment means is configured for attachment to the third attachment means, and wherein the fourth attachment means is configured for attachment to one or more portions of webbing attached along a panel.

In a first related embodiment, the first attachment means includes a fastening technology such as, for example, snaps, hook and loop fasteners, adhesive agents, or magnets.

In a second related embodiment, the first application member includes a gear piece and the second attachment means includes a rail. In a preferred version of the second related embodiment, the third attachment means includes an elongated receiving track for receiving the rail and, preferably, the rail further includes a locking stub and the interface member further includes a locking portal, wherein the locking stub can be removably locked in place along the locking portal by sliding the rail of the application member along the receiving track of the interface member until the locking stub at least partially slides into the locking portal.

In another preferred version of the second related embodiment, the interface member further includes a plurality of elongated plates including a first plate and a second plate wherein the plates are joined to one another adjacent proximal ends of the plates, respectively, wherein the interface member is configured so that an inner surface of the first plate faces an inner surface of the second plate; and wherein the fourth attachment means further includes one or more pairs of fasteners located between the inner surface of the first plate and the inner surface of the second plate, whereby each pair of fasteners can be fastened together to confine webbing from a webbed panel between the first plate and the second plate, thereby attaching the interface member to a webbed panel. Preferably, the first attachment means and the fourth attachment means include snaps, hook and loop fasteners, adhesive agents, or magnets.

In an alternative preferred version of the second related embodiment, the apparatus further includes an elongated tab, wherein the interface member further includes an entrance aperture and a receiving corridor, and the fourth attachment means includes one or more indentations along a first side of the interface member; wherein webbing from a panel may be situated along the one or more indentations and the tab may be inserted through the entrance aperture and along the receiving corridor whereby the webbing is trapped between the interface member and the tab, thereby attaching the interface member to a webbed panel.

In a third related embodiment, the first application member further includes a gear piece, the second attachment means includes a receiving track, and the third attachment means includes a rail, whereby the second attachment means can be attached to the third attachment means by sliding the rail within the receiving track. In a preferred version of the third related embodiment, the interface member further includes a plurality of interface sub-members, and the fourth attach means includes a fastener on each interface sub-member for attaching each interface sub-member to webbing along a webbed panel. The fasteners are preferably snaps, hook and loop fasteners, adhesive agents, or magnets.

In an alternative preferred version of the third related embodiment, the interface member further includes a plurality of elongated plates including a first plate and a second plate wherein the plates are joined to one another adjacent proximal ends of the plates, respectively, wherein the interface member is configured so that an inner surface of the first plate faces an inner surface of the second plate; and wherein the fourth attachment means further includes one or more pairs of fasteners located between the inner surface of the first plate and the inner surface of the second plate, whereby each pair of fasteners can be fastened together to confine webbing from a webbed panel between the first plate and the second plate, thereby attaching the interface member to a webbed panel. Preferably, the first attachment means and the fourth attachment means include snaps, hook and loop fasteners, adhesive agents, or magnets. Preferably, the interface member includes a locking extension and the tab includes a locking aperture, whereby the tab may be removably locked in place along the locking extension by sliding the tab along the receiving corridor until the locking extension at least partially slides into the locking aperture. Alternatively or additionally, the rail further includes a locking stub and the interface member further includes a locking portal, wherein the locking stub can be removably locked in place along the locking portal by sliding the rail of the application member along the receiving track of the interface member until the locking stub at least partially slides into the locking portal. Alternatively or additionally, the rail further includes a plurality of sub-rails. Alternatively or additionally, the tab further includes a ledge extending from the tab surface adjacent a first end of the tab.

In another aspect, embodiments of the invention provide a system for attaching an object to a webbed panel, the system including an application member including a first attachment member located along a first surface of the application member and a second attachment member located along a second surface of the application member; and an interface member including a third attachment member located along a first surface of the interface member and a fourth attachment member located along a second surface of the interface member, wherein the first attachment member is configured for attaching the application member to an object, wherein the second attachment member is configured for attachment to the third attachment member, and wherein the fourth attachment member is configured for attachment to a webbed panel.

In yet another aspect, embodiments of the invention provide an apparatus for attaching an object to a webbed panel. The apparatus includes an application member including a gear piece, a receiving track and a locking portal; and an interface member including a rail and an attachment member configured for attachment to a webbed panel, wherein the rail includes a locking stub wherein the locking stub can be removably locked in place along the locking portal by sliding the receiving track of the application member along the rail of the interface member until the locking stub at least partially slides into the locking portal. Preferably, the apparatus further includes a plurality of interface members including a first interface member and a second interface member, the first interface member including a first rail and a first fastener, and the second interface member including a second rail and a second fastener, wherein the first fastener and the second fastener are configured for attachment to a webbed panel.

The previously summarized exemplary embodiments of the present invention have many advantages, including, without limitation, quick attachment and/or release of gear pieces to load-carrying equipment; the option to attach a tab and an interference member to load-carrying equipment prior to attaching gear pieces themselves, which may be bulky, heavy, or otherwise unwieldy; and the ability to quickly interchange gear pieces that have the same sized application member. With regard to the latter example, a first gear piece of a first size attached to a vest may carry ammunition, and a second gear piece with of the first size may also carry ammunition. Instead of loading the first gear piece with new ammunition after depletion of old ammunition, the second gear piece—already full of ammunition—may quickly and conveniently be interchanged with the first gear piece so that the second gear piece is attached to the vest. In a related example, a third gear piece of the first size may carry cold weather survival clothing. If the cold weather survival clothing is more desirable than extra ammunition at a certain time, the third gear piece may quickly be interchanged with the second gear piece on the vest. In high intensity environments (e.g., war zones), the luxury of efficient interchangeability of various types of items is considerably desirable and may mean the difference between life and death.

### BRIEF DESCRIPTION OF THE DRAWINGS

Further features, aspects, and advantages of the present invention will become better understood by reference to the following detailed description and accompanying figures, wherein elements are not to scale so as to more clearly show the details, wherein like reference numbers indicate like elements throughout the several views, and wherein:

FIG. 1 shows a perspective view of a prior art example of a webbing panel in the conventional PALS format;

FIG. 2 shows a perspective view of a prior art example of a conventional gear piece that may be weaved through and attached to the panel shown in FIG. 1;

FIG. 3 shows a perspective view of an embodiment of an interlocking apparatus for attaching a gear piece to a load-carrying equipment piece;

FIG. 3A shows a close-up view of the area designated as “A” in FIG. 3;

FIG. 3B shows a close-up view of the area designated as “B” in FIG. 3;

FIG. 3C shows a close-up view of the area designated as “C” in FIG. 3;

FIG. 3D shows a close-up view of the area designated as “D” in FIG. 3;

FIG. 4 shows a perspective view of an embodiment of an interlocking apparatus for attaching a gear piece to a load-carrying equipment piece;

FIG. 5 shows a top view of the interlocking apparatus shown in FIG. 1;

FIG. 6 shows a back side view of the interlocking apparatus shown in FIG. 1;

FIG. 7 shows a front side view of the interlocking apparatus shown in FIG. 1;

FIG. 8 shows a side view of the interlocking apparatus shown in FIG. 1;

FIG. 9 shows a perspective view of a tab that makes up part of the interlocking apparatus shown in FIG. 1;

FIG. 9A shows a close-up view of the area designated as “A” in FIG. 9;

FIG. 9B shows a close-up view of the area designated as “B” in FIG. 9;

FIG. 10 shows a back side view of the tab shown in FIG. 9;

FIG. 11 shows a side view of the tab shown in FIG. 9;

FIG. 12 shows a perspective view of an interface member that makes up part of the interlocking apparatus shown in FIG. 1;

FIG. 12A shows a close-up view of the area designated as “A” in FIG. 12;

FIG. 13 shows a back side view of the interface member shown in FIG. 12;

FIG. 14 shows a side view of the interface member shown in FIG. 12;

FIG. 14A shows a close-up view of the area designated as “B” in FIG. 14;

FIG. 15 shows a top view of the interface member shown in FIG. 12;

FIG. 16 shows a perspective view of an application member that makes up part of the interlocking apparatus shown in FIG. 1;

FIG. 16A shows a close-up view of the area designated as “A” in FIG. 16;

FIG. 16B shows a close-up view of the area designated as “B” in FIG. 16;

FIG. 17 shows a front view of the application member shown in FIG. 16;

FIG. 18 shows a top view of the application member shown in FIG. 16;

FIG. 19 shows a side view of the application member shown in FIG. 16;

FIG. 20 shows a rear view of a modified gear piece including a modified application member attached to a gear piece;

FIG. 21 shows a side view of a plurality of interface members, each interface member including a fastener and a rail for attaching the interface members to another object(s);

FIG. 22 shows a top down view of the top interface member shown in FIG. 21;

FIG. 23 shows a side view of an embodiment of a non-assembled interlocking apparatus;

FIG. 24 shows a side view of an interface member; and

FIG. 25 shows a perspective view of an interface member.

### DETAILED DESCRIPTION

Various terms used herein are intended to have particular meanings. Some of these terms are defined below for the purpose of clarity. The definitions given below are meant to cover all forms of the words being defined (e.g., singular, plural, present tense, past tense). If the definition of any term below diverges from the commonly understood and/or dictionary definition of such term, the definitions below control.
Attach: To physically connect a first object to a second object either directly or indirectly. Any form of the term “attach” as stated in this disclosure is to be interpreted broadly as encompassing permanent attachment or removable attachment capability unless otherwise expressly limited herein.
Equipment: items including motorized vehicles including cars, trucks, boats, and airplanes; clothing and clothing accessories including belts, body straps, and body armor; packs, bags, sacks of various shapes and materials; weapons; tools; illumination devices; audio transmission and/or reception devices; and electromagnetic wave transmission and reception devices.
Gear Piece: a primary object of any shape or configuration, typically weighing less than about 50 kilograms, which can be attached to a secondary object wherein the secondary object can be attached to load carrying equipment, thereby effectively attaching the primary object to the load carrying equipment. A gear piece can be made to hold solids, liquids, or gases depending on the purpose of the gear piece.
Load Carrying Equipment: any equipment configured for attaching objects to such equipment for storage or transport of such objects.
MOLLE: an acronym for “Modular Lightweight Load-carrying Equipment.”
PALS: an acronym for “Pouch Attachment Ladder System.”
Pouch Attachment Ladder System: An interlocking attaching system as described in U.S. Pat. No. 5,724,707 to John Kirk et al. entitled “Interlock Attaching Strap System,” the entire content of which are incorporated herein by reference in its entirety.

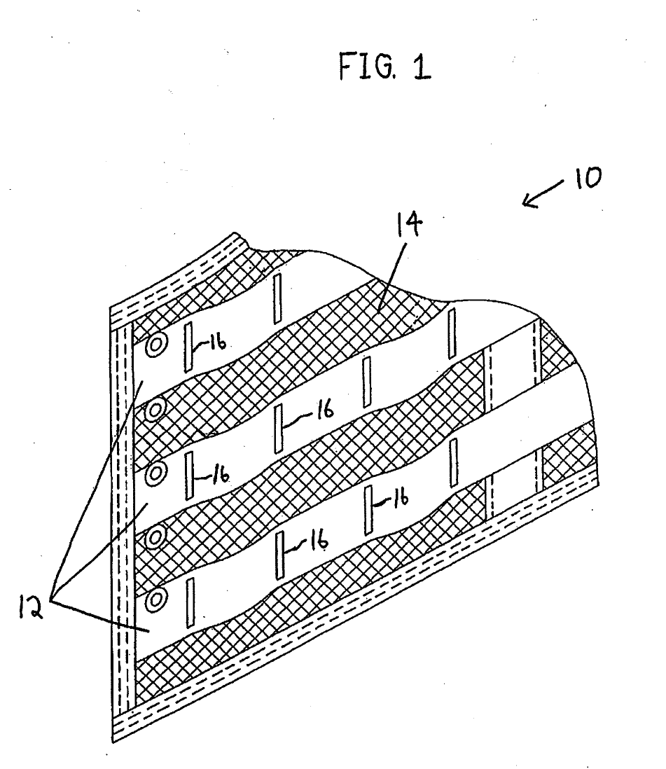

FIG. 1 shows a conventional panel 10 that includes the Pouch Attachment Ladder System (PALS) webbing that typically includes a plurality of horizontal rows 12 of webbing (typically about 1 inch wide) spaced about 1 inch apart from one another. Each row is typically attached to backing material 14 at a plurality of attachment points 16 about every 1.5 inches. The panel 10 is typically sewn or otherwise attached to a piece of load-carrying equipment. Panels such as the panel 10 shown in FIG. 1 come in a variety of shapes and sizes depending upon what the panels are intended to be attached to. Examples of load-carrying equipment that the panel 10 could be attached to include, for example, a vest (e.g. the Fighting Load Carrier (FLC) used by the U.S. Military), a belt, a rucksack (e.g., the MOLLE Rucksack used by the U.S. Army), and a backpack (e.g., for hiking or camping).

FIG. 2 shows a conventional gear piece 18 that may be attached to a PALS panel such as the panel 10 shown in FIG. 1. Conventional gear pieces such as the gear piece 18 shown in FIG. 2 typically include straps 20 or other similar attachment means that may be threaded through the rows 12 of the panel 10. The rows 12 of webbing are often very tight against the backing material 14, making the process of attaching a gear piece to the rows 12 time-consuming and cumbersome. For example, in order to attach the straps 20 of the gear piece 18 to the panel 10, the straps would each need to be carefully woven through the rows 12 of webbing and then securely attached to the panel using attachment members such as a pair of snaps 22 shown in FIG. 2. The gear piece 18 shown in FIG. 2 is typically only one of many gear pieces that may need to be attached to the panel 10. Additionally, many types of gear pieces are large and unwieldy, increasing the time and effort to attach such gear pieces to a panel such as the panel 10 shown in FIG. 1.

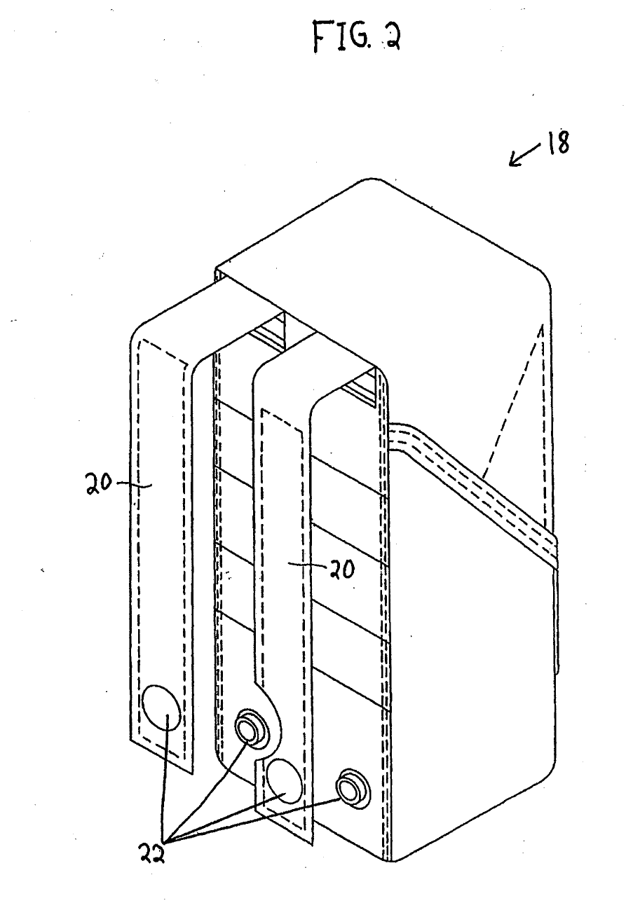

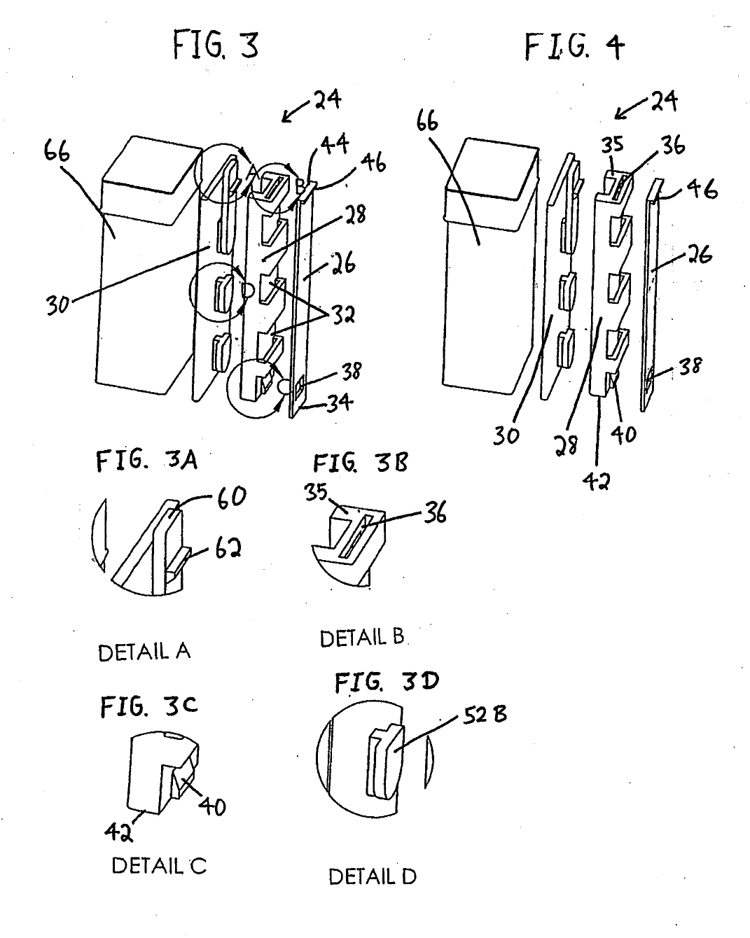

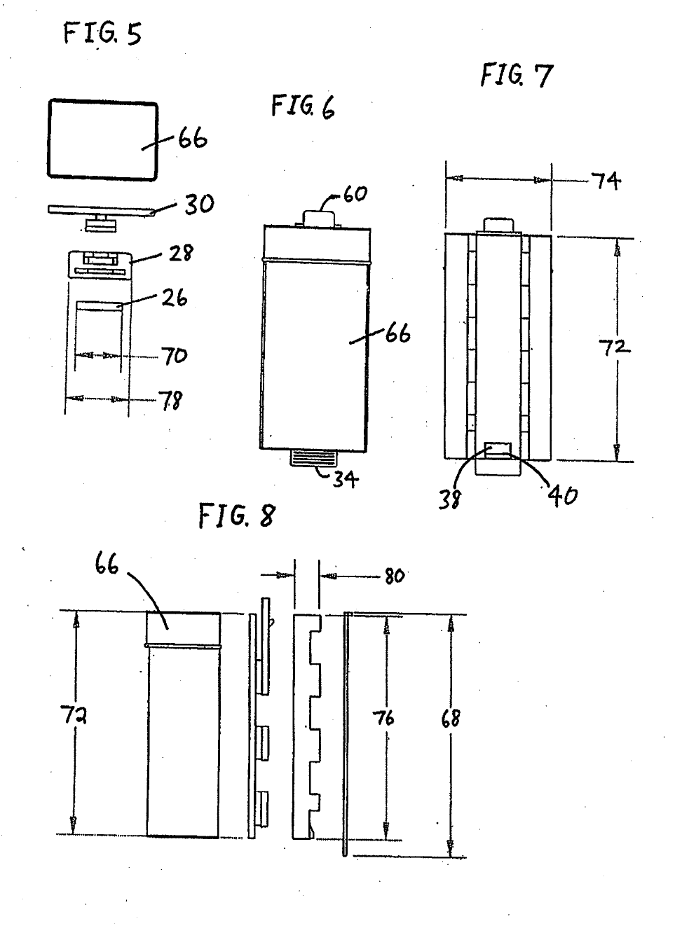

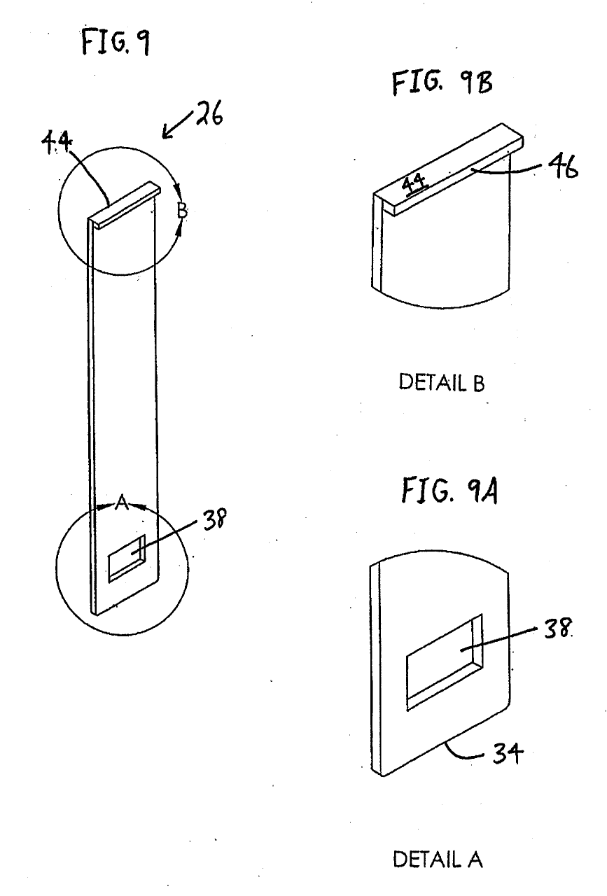

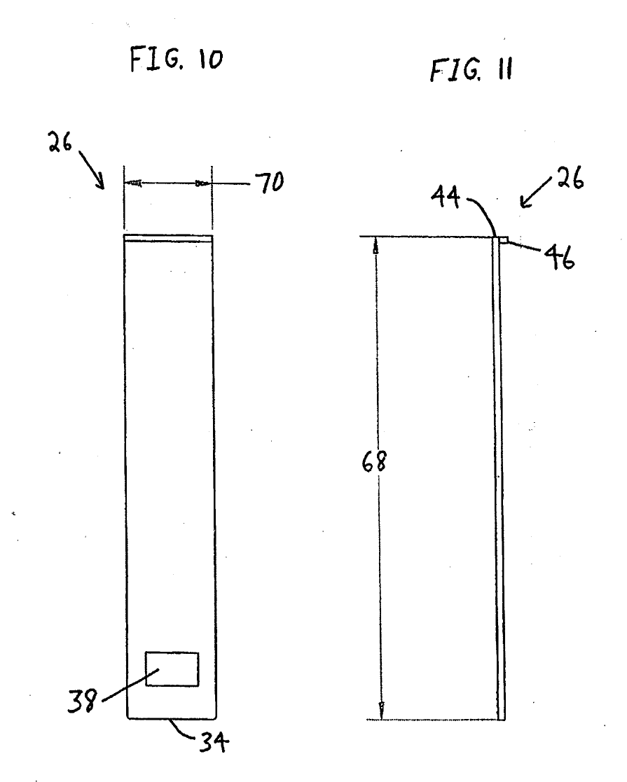

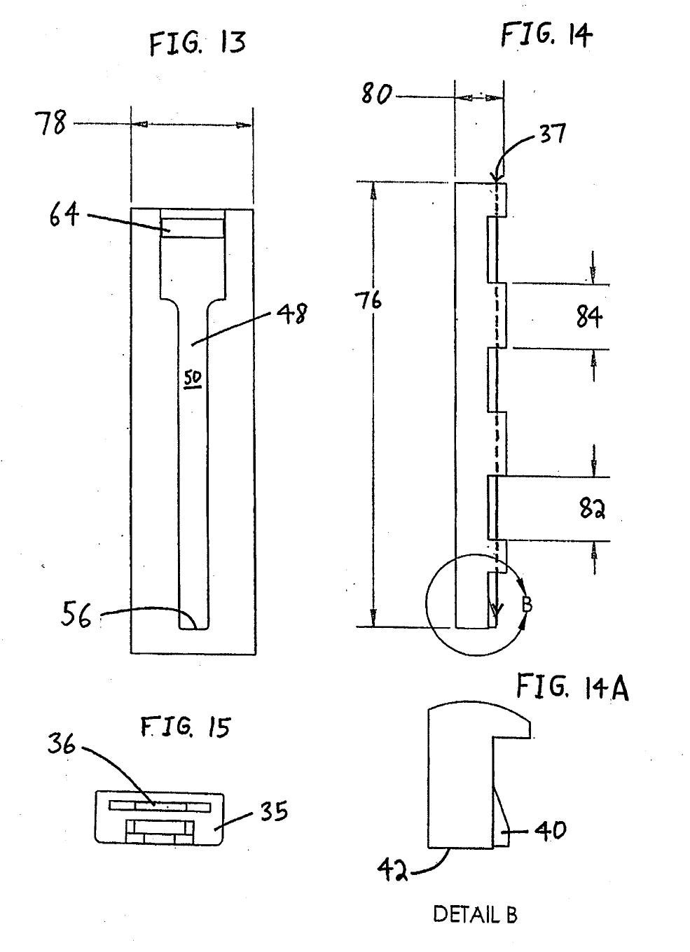

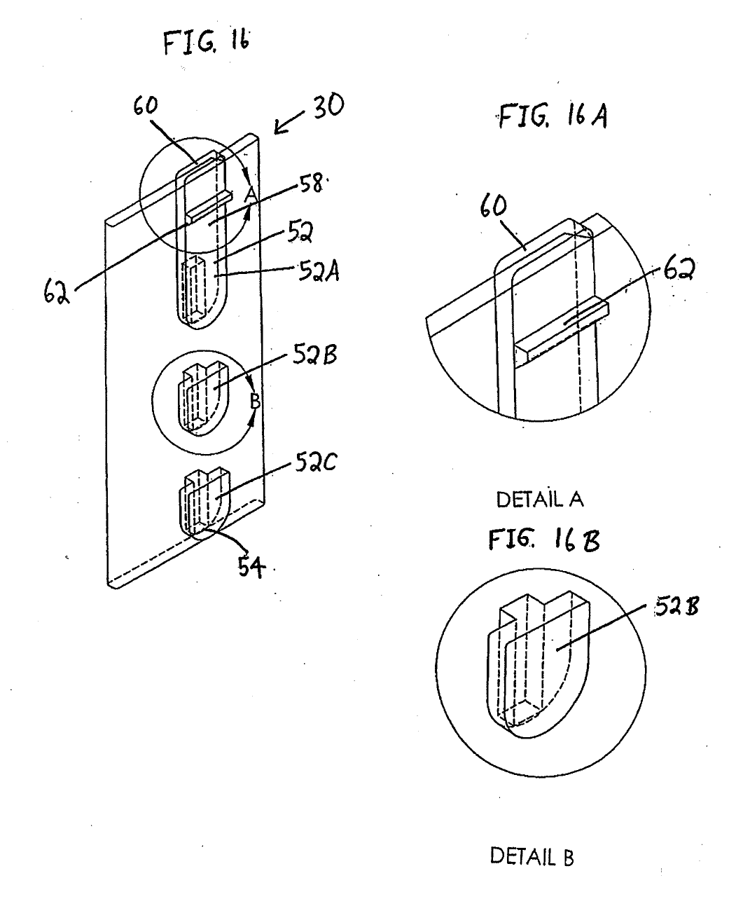

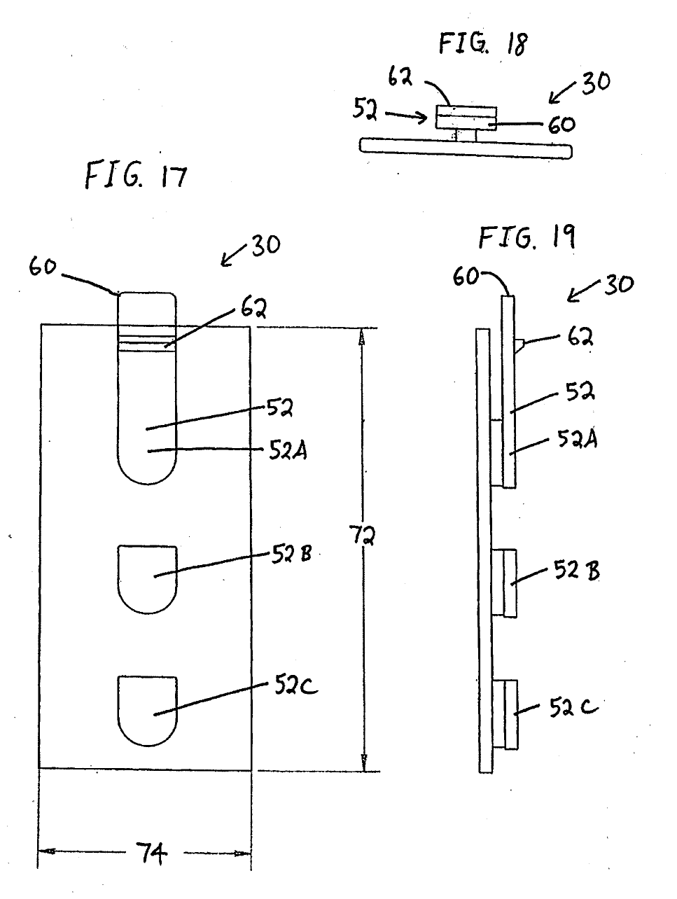

FIGS. 3-19 show an embodiment of an alternative to conventional gear piece attachment mechanisms and systems, according to the present disclosure. The embodiment includes an interlocking apparatus 24 for attaching a gear piece to a load-carrying equipment piece. The apparatus 24 includes a tab 26, an interface member 28, and an application member 30. The apparatus 24 is configured so that the tab 26 and the interface member 28 may be quickly and conveniently attached to load-carrying equipment utilizing the PALS system (e.g., the panel 10 shown in FIG. 1). More specifically, for example, a plurality of indentations 32 along the interface member 28 may be aligned with at least some of the rows 12 along the panel 10. A first end 34 of the tab 26 may then be inserted through an entrance aperture 36 near a second end 35 of the interface member 28. The first end 34 of the tab 26 may then be guided along the interface member 28 along a receiving corridor 37 (FIG. 14) such that at least some of the rows 12 are lodged between the interface member 28 and the tab 26, thereby substantially securely attaching the tab 26 and the interface member 28 to the panel 10. In a preferred embodiment, the tab 26 may be locked into place by advancing a locking aperture 38 located near the first end 34 of the tab 26 to a position adjacent a locking extension 40 located near a first end 42 of the interface member 28. A close-up of the locking aperture 38 is shown in FIG. 9A and a close-up of the locking extension 40 is shown in FIGS. 3C and 14B. The tab 26 may be removed from the interface member 28 by (1) causing the first end 34 of the tab 26 to bend away from the interface member 28, freeing the locking aperture 38 from the locking extension 40, and (2) pulling a second end 44 of the tab 26. As shown in a close-up view in FIG. 9B, the second end 44 of the tab 26 preferably includes a ledge 46 for facilitating the removal of the tab 26 from the interface member 28.

After the interface member 28 and the tab 26 are attached to the panel 10 and to one another, a receiving track 48 along a rear side 50 of the interface member 28 remains exposed. The application member 30, including at least one rail 52 configured for sliding along the track 48 of the interface member 28, may quickly and conveniently be attached to the interface member 28 by inserting the rail 52 into the track 48 until a first end 54 of the rail 52 reaches or travels substantially near a terminus 56 of the track 48. In some embodiments, the rail 52 includes an extension platform 58 located near a second end 60 of the rail 52 that further includes locking stub 62. The locking stub 62 is for engaging with a locking portal 64 located near the second end 35 of the interface member 28 along the rear side 50. In the embodiment shown in FIGS. 3, 4, 8, 16, 17, and 19, the rail 52 is sub-divided into a plurality of sub-rails 52A, 52B, and 52C. However, in alternate embodiments, the rail may be a unitary member. The application member 30 may be quickly and conveniently removed from the interface member 28 by causing the extension platform 58 to bend away from the interface member 28, freeing the locking stub 62 from the locking portal 64, and pulling the application member 30 so that the rail 52 exits the track 48.

In a preferred embodiment, the application member 30 is attached to a gear piece 66 (e.g., a modular pouch) so that the gear piece 66 may quickly and conveniently be attached or removed from an interface member attached to load-carrying equipment. In such an embodiment, the application member 30 could be formed as part of the gear piece, such as by injection molding a gear piece enclosure with an application member on a portion thereof, or sewn or glued onto a portion of the gear piece or by other means known in the art. In an alternative embodiment, the gear piece 66 may be attached to the application member 30 using, for example, Velcro, snaps, and/or other fastening means known to a person having ordinary skill in the art.

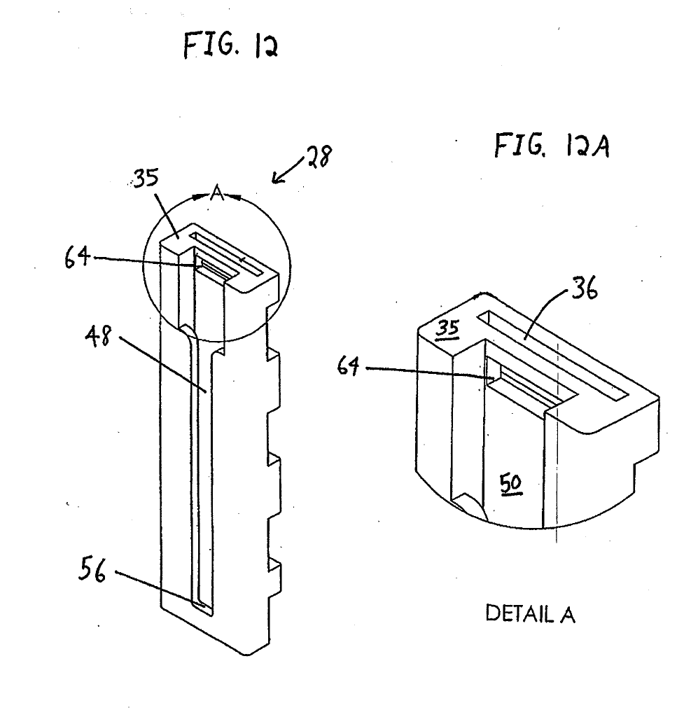

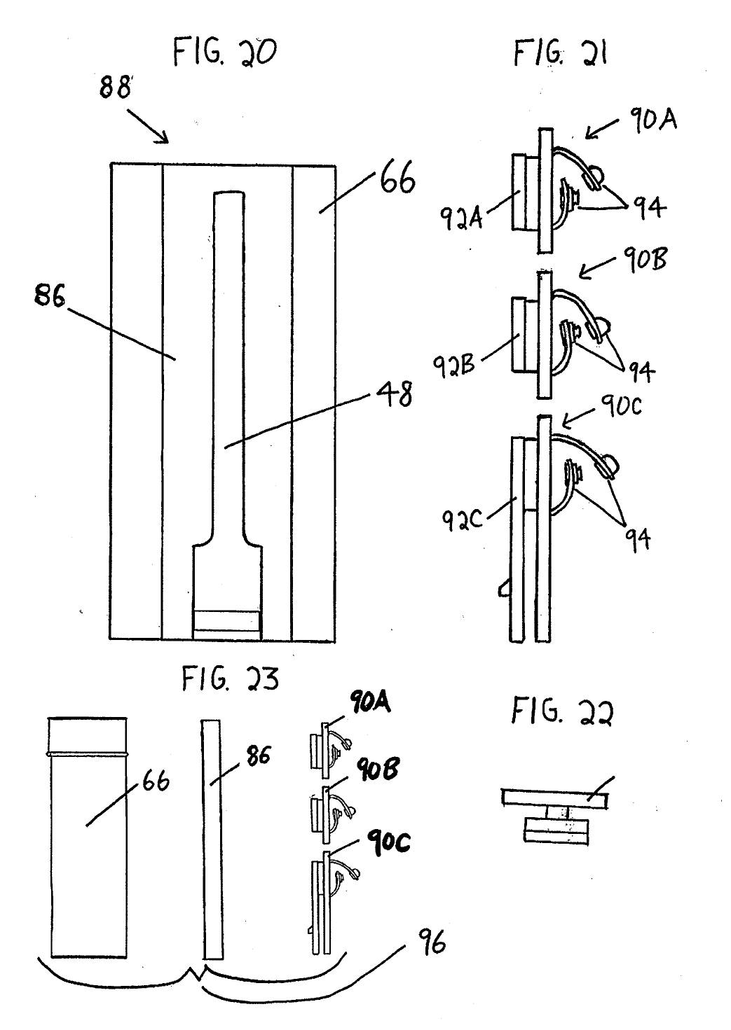

FIGS. 20-23 show another embodiment of an alternative to conventional gear piece attachment mechanisms and systems. FIG. 20 shows the gear piece 66 attached to a second application member 86 to form a modified gear piece 88. The second application member 86 is similar to the interface member 28 shown in FIG. 12, but the second application member 86 does not include a receiving corridor 36 and is therefore typically narrower than the interface member 28. The second application member 86 is configured for removable attachment to one or more second interface members 90 (90A, 90B, and 90C), the one or more second interface member(s) 90 each including a rail 92 (92A, 92B, and 92C) as shown in FIG. 21. FIG. 22 shows a top down view of the top second interface member 92A shown in FIG. 21. The second interface members 90 are preferably attachable to an object such as, for example, a PALS panel by a fastener 94 such as, for example, snaps or hook and loop fasteners (e.g., Velcro® brand hook and loop fasteners). After one or more second interface members 90 are attached to a first object (e.g., the panel 10 described with respect to FIG. 1) in substantially linear fashion, a second object (e.g., the modified gear piece 88) can be attached to the second application member 86 by sliding the second application member 86 down across the rails 92 of the second interface members so that the rails 92 are captured within the receiving track 48 of the second application member 86. FIG. 23 shows a side view of a second interlocking apparatus 96 including the second application member 86, the second interface members 92, and, preferably, the gear piece 66 prior to attachment of these parts to one another.

FIG. 24 shows another embodiment including a third interface member 98, the third interface member including a pair of elongate plates 100 including a first plate 100A and a second plate 100B. The plates 100 are joined at the respective proximal ends of each plate 100 and are configured such that an inner surface 102 of the first plate 100A faces an inner surface 104 of the second plate 100B. One or more fasteners 104 are located between the plates 100 so that the inner surfaces (102, 104) of the plates 100 can be attached at one or more locations along the inner surfaces (102, 104) of the plates 100. In the example shown in FIG. 24, the fasteners 104 are shown as snaps. Other examples of fasteners 104 can include, for example, magnets or hook and loop fasteners (e.g., Velcro® brand hook and loop fasteners). An outside surface 106 of the second plate 100B includes one or more rails 108. The rail(s) 108 can be attached, for example, to the second application member 86 shown in FIG. 20 and FIG. 23. The third interface member 98 is configured so that the first plate 100A may be quickly slid through webbing such as, for example, the rows 12 on the PALS panel 10 shown in FIG. 1. The fasteners 104 can then be fastened to one another such that the third interface member 98 is effectively fastened to load carrying equipment.

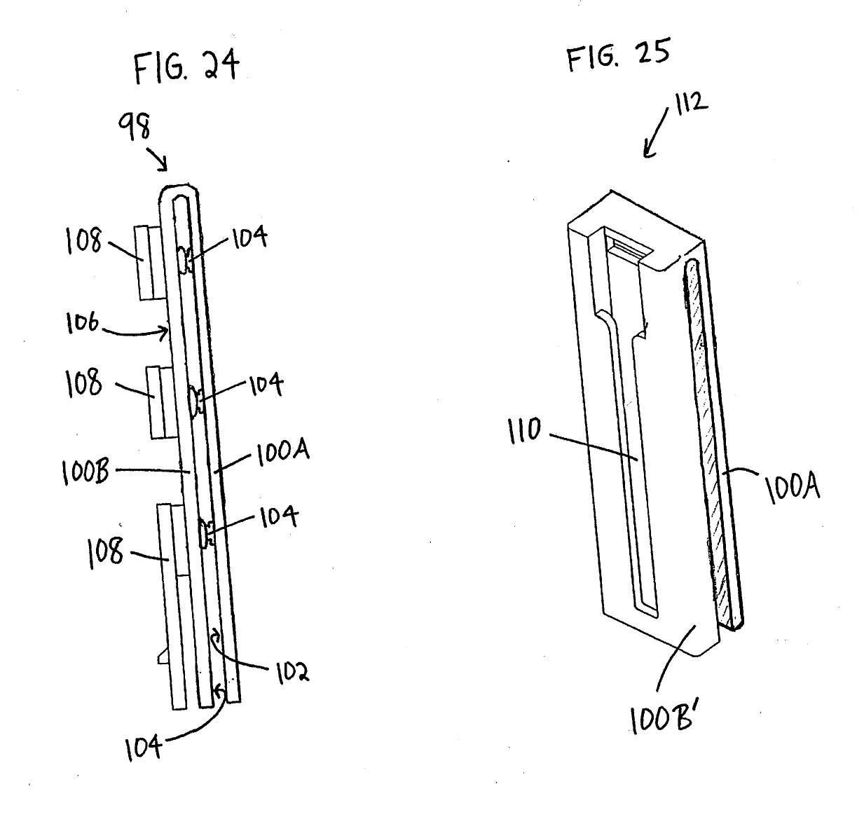

In a related embodiment shown in FIG. 25, a modified second plate 100B′ includes a receiving track 110 instead of the one or more rails 108. In this embodiment, a fourth interface member 112 can be attached to an application member such as, for example, the attachment member 30 shown in FIGS. 16-19. As with the embodiment shown in FIG. 24, fasteners also are located between the first plate 100A and the modified second plate 102B′ of the fourth interface member 112.

The tab 26, the application member 30, and the second application member 86 are preferably resilient, lightweight, and flexible and are preferably made of polymeric materials. The tab 26, the application member 30, and the second application member 86, however, may be made of any suitable material known to a person having ordinary skill in the art for the applications described herein. To give a sense of typical scale, a specific example of a length 68 for the tab 26 is about 7.45 inches and a specific example of a width 70 for the tab 26 is about 1.40 inches. A specific example of a length 72 for the application member 30 is about 6.85 inches and a specific example of a width 74 for the application member 30 is about 3.25 inches. As with the tab 26 and the application member 30, the interface member 28, the second interface member 90, the third interface member 98, and the fourth interface member 112 are preferably resilient and lightweight. The interface member 28, the second interface member 90, the third interface member 98, and the fourth interface member 112 also preferably have a high tensile strength. Therefore, the interface member 28, the second interface member 90, the third interface member 98, and the fourth interface member 112 are preferably made of high tensile strength plastic, metal, or other similar material known to a person having ordinary skill in the art. A specific example of a length 76 for the interface member 28 is about 6.85 inches; a specific example of a width 78 for the interface member 28 is about 1.90 inches; a specific example of a thickness 80 of the interface member 28 is about 0.75 inches; a specific example a length 82 of the individual indentations 32 along the interface member 28 is about 1.00 inches; and a specific example of a length 84 of the region or regions between the indentations 32 along the interface member 28 is about 1.00 inches. Although specific examples of dimensions are given for the tab, interface member, and application member, various dimensions are contemplated by this disclosure and the specific dimensions given herein are for illustrative purposes and are not meant to be limiting.

The present disclosure also includes a method for quickly and securely attaching a gear piece to load-carrying equipment. A preferred embodiment of the method includes the steps of (200) aligning a plurality of indentations on an interface member (e.g., the interface member 28 shown in FIG. 3) with one or more rows of webbing located on a panel configured with PALS (e.g., the panel 10 shown in FIG. 1); (202) attaching a tab (e.g., the tab 26 shown in FIG. 3) to the interface member; and (204) attaching an application member (e.g., the application member 30 shown in FIG. 3) to the interface member.

In a related embodiment, a method for quickly and securely attaching a gear piece to load-carrying equipment includes the steps of (300) attaching one or more second interface members 92 to a target object (e.g., a PALS panel); (302) attaching the gear piece 66 to an application member (e.g., the second application member 86), thereby forming a second gear piece 88; and (304) attaching the second gear piece 88 to the one or more second interface members 92 by sliding the receiving track 48 of the second application member 86 along the rail(s) 90 so as to attach the gear piece 66 to the target object.

Various embodiments of the underlying concepts disclosed herein may be used in a wide range of professions and activities. For example, applications include military gear, law enforcement gear, hunting gear, fishing gear, camping gear, hiking gear, and any other application in which various types and sizes of containers may be used in a modular format.

The previously described embodiments of the present invention have many advantages, including quick attachment and/or release of gear pieces to load-carrying equipment; the option to attach a tab and an interference member to load-carrying equipment prior to attaching gear pieces themselves, which may be bulky, heavy, or otherwise unwieldy; and the ability to quickly interchange gear pieces that have the same sized application member. With regard to the latter example, a first gear piece of a first size attached to a vest may carry ammunition, and a second gear piece with of the first size may also carry ammunition. Instead of loading the first gear piece with new ammunition after depletion of old ammunition, the second gear piece—already full of ammunition—may quickly and conveniently be interchanged with the first gear piece so that the second gear piece is attached to the vest. In a related example, a third gear piece of the first size may carry cold weather survival clothing. If the cold weather survival clothing is more desirable than extra ammunition at a certain time, the third gear piece may quickly be interchanged with the second gear piece on the vest. In high intensity environments (e.g., war zones), the luxury of efficient interchangeability of various types of items is considerably desirable and may mean the difference between life and death.

The foregoing description of preferred embodiments for the present invention has been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

Any element in a claim that does not explicitly state “means for” performing a specified function, or “step for” performing a specific function, is not to be interpreted as a “means” or “step” clause as specified in 35 U.S.C. § 112, ¶6. In particular, the use of “means” in the claims herein is not intended to invoke the provisions of 35 U.S.C. § 112, ¶6.

What is claimed is:

1. An apparatus for attaching an object to a webbed panel, the apparatus comprising an application member including a first attachment means on a first surface of the application member and a second attachment means on a second surface of the application member; and an interface member including a third attachment means along a first surface of the interface member and a fourth attachment means along a second surface of the interface member, wherein the first attachment means is configured for attaching the application member to an object, wherein the second attachment means is configured for attachment to the third attachment means, and wherein the fourth attachment means is configured for attachment to one or more portions of webbing attached along a panel.

2. The apparatus of claim 1 wherein the first attachment means comprises a fastening technology selected from the group consisting of snaps, hook and loop fasteners, adhesive agents, and magnets.

3. The apparatus of claim 1 wherein the first application member further comprises a gear piece and wherein the second attachment means comprises a rail.

4. The apparatus of claim 1 wherein the first application member further comprises a gear piece, the second attachment means comprises a receiving track, and the third attachment means comprises a rail, whereby the second attachment means can be attached to the third attachment means by sliding the rail within the receiving track.

5. The apparatus of claim 3 wherein the third attachment means comprises an elongated receiving track for receiving the rail.

6. The apparatus of claim 3 further comprising an elongated tab, wherein the interface member further comprises an entrance aperture and a receiving corridor, and the fourth attachment means comprises one or more indentations along a first side of the interface member; wherein webbing from a panel may be situated along the one or more indentations and the tab may be inserted through the entrance aperture and along the receiving corridor whereby the webbing is trapped between the interface member and the tab, thereby attaching the interface member to a webbed panel.

7. The apparatus of claim 4 wherein the interface member further comprises a plurality of interface sub-members, and wherein the fourth attach means comprises a fastener on each interface sub-member for attaching each interface sub-member to webbing along a webbed panel.

8. The apparatus of claim 4 wherein the interface member further comprises a plurality of elongated plates including a first plate and a second plate wherein the plates are joined to one another adjacent proximal ends of the plates, respectively, wherein the interface member is configured so that an inner surface of the first plate faces an inner surface of the second plate; and wherein the fourth attachment means further comprises one or more pairs of fasteners located between the inner surface of the first plate and the inner surface of the second plate, whereby each pair of fasteners can be fastened together to confine webbing from a webbed panel between the first plate and the second plate, thereby attaching the interface member to a webbed panel.

9. The apparatus of claim 5 wherein the rail further comprises a locking stub and wherein the interface member further comprises a locking portal, wherein the locking stub can be removably locked in place along the locking portal by sliding the rail of the application member along the receiving track of the interface member until the locking stub at least partially slides into the locking portal.

10. The apparatus of claim 5 wherein the interface member further comprises a plurality of elongated plates including a first plate and a second plate wherein the plates are joined to one another adjacent proximal ends of the plates, respectively, wherein the interface member is configured so that an inner surface of the first plate faces an inner surface of the second plate; and wherein the fourth attachment means further comprises one or more pairs of fasteners located between the inner surface of the first plate and the inner surface of the second plate, whereby each pair of fasteners can be fastened together to confine webbing from a webbed panel between the first plate and the second plate, thereby attaching the interface member to a webbed panel.

11. The apparatus of claim 6 wherein the interface member comprises a locking extension and wherein the tab comprises a locking aperture, whereby the tab may be removably locked in place along the locking extension by sliding the tab along the receiving corridor until the locking extension at least partially slides into the locking aperture.

12. The apparatus of claim 6 wherein the rail further comprises a locking stub and wherein the interface member further comprises a locking portal, wherein the locking stub can be removably locked in place along the locking portal by sliding the rail of the application member along the receiving track of the interface member until the locking stub at least partially slides into the locking portal.

13. The apparatus of claim 6 wherein the rail further comprises a plurality of sub-rails.

14. The apparatus of claim 6 wherein the tab further comprises a ledge extending from the tab surface adjacent a first end of the tab.

15. The apparatus of claim 7 wherein the fasteners are selected from the group consisting of snaps, hook and loop fasteners, adhesive agents, and magnets.

16. The apparatus of claim 8 wherein the first attachment means and the fourth attachment means each comprise a fastening technology selected from the group consisting of snaps, hook and loop fasteners, adhesive agents, and magnets.

17. The apparatus of claim 10 wherein the first attachment means and the fourth attachment means each comprise a fastening technology selected from the group consisting of snaps, hook and loop fasteners, adhesive agents, and magnets.

18. A system for attaching an object to a webbed panel, the system comprising an application member including a first attachment member located along a first surface of the application member and a second attachment member located along a second surface of the application member; and an interface member including a third attachment member located along a first surface of the interface member and a fourth attachment member located along a second surface of the interface member, wherein the first attachment member is configured for attaching the application member to an object, wherein the second attachment member is configured for attachment to the third attachment member, and wherein the fourth attachment member is configured for attachment to a webbed panel.

19. An apparatus for attaching an object to a webbed panel, the apparatus comprising:
an application member including a gear piece, a receiving track and a locking portal; and
an interface member including a rail and an attachment member configured for attachment to a webbed panel, wherein the rail includes a locking stub wherein the locking stub can be removably locked in place along the locking portal by sliding the receiving track of the application member along the rail of the interface member until the locking stub at least partially slides into the locking portal.

20. The apparatus of claim 19 further comprising a plurality of interface members including a first interface member and a second interface member, the first interface member including a first rail and a first fastener, and the second interface member including a second rail and a second fastener, wherein the first fastener and the second fastener are configured for attachment to a webbed panel.
